(19) United States
(12) Patent Application Publication
(10) Pub. No.: US 2003/0086360 A1
(43) Pub. Date: May 8, 2003

(54) Optical disk, copy preventive method, and recordable optical disk

(75) Inventors: Toshio Suzuki, Tokorozawa-shi (JP); Shoji Taniguchi, Tokorozawa-shi (JP); Fumihiko Yokogawa, Tsurugashima-shi (JP); Seiichi Ohsawa, Tsurugashima-shi (JP); Yoshitsugu Araki, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/287,581

(22) Filed: Nov. 5, 2002

(30) Foreign Application Priority Data
Nov. 6, 2001 (JP) 2001-340350

(51) Int. Cl. G11B 7/24

(52) U.S. Cl. 369/275.3

(57) ABSTRACT

So as to prevent from illegally copying and illegally reproducing data with reliability, a ROM disk comprises: a data area where data to be reproduced is recorded; and a PEP area where the information necessary to reproduce the data recorded in the data area is recorded in the form of the zonal pit rows, and a recordable optical disk records a signal which prevents from recording the zonal pit rows into the area which is equivalent to the PEP area of the ROM disk, of the recordable optical disk.

### BACKGROUND OF THE INVENTION

1. Field of the Invention

The present invention relates to a technical field regarding an optical disk, a copy preventive method, and a recordable optical disk so as to control duplication of data appropriately.

2. Description of the Related Art

In the view of copyright protection and so forth, there is getting to be a problem that makes data duplication from a read-only optical disk (thereinafter ‘ROM disk’) to a recordable optical disk with the RF (radio frequency wave) Copy technology. The RF Copy technology is the recording method using the signal that is detected by a optical pick-up and shaped up by an adequate equalizer. When the data recorded on a ROM disk is copied onto a recordable optical disk such as an R disk (Write at Once disk) or an RW disk (Rewritable disk) or the like, which is equivalent to a ROM disk in its reproduction characteristic, the same disk as the original ROM disk in its structure is produced. Therefore, it is possible to reproduce the data copied on the recordable optical disk with the RF Copy technology, as well as to reproduce the data recorded on a ROM disk.

In order to prevent reproducing data recorded on a disk which is illegally copied with RF Copy technology, the method described below as an example is known. After comparing a medium identification information (Book Type) in control data recorded on the disk with the original physical characteristic of the disk, such as the presence or the absence of a wobble groove or the presence or the absence of LPP or the like, it is possible to decide whether or not it is permissible to reproduce the data on the disk on the basis of the result of the comparison when data is reproduced.

However, in this above-mentioned method that the decision is done on reproducing, some detecting circuit for detecting the presence or the absence of a wobble groove or the physical characteristic of a disk or the like is needed. This detecting circuit is not necessary for reproducing data on a disk essentially, and may lead an increase in cost of the reproducing apparatus. Furthermore, there is the possibility that the reproducing apparatus may be manipulated so as to invalidate the functions of the detecting circuit, such as the detecting line is disconnected or the controlling software patches up or the like.

### SUMMARY OF THE INVENTION

The present invention is made in consideration of the aforementioned problems. It is an object of the present invention to provide an optical disk, a copy preventive method, and a recordable optical disk so as to prevent from illegally copying and illegally reproducing data with reliability.

The above object of the present invention can be achieved by an optical disk (100) provided with: a data area where data to be reproduced is recorded; and a PEP (Phase Encoded Part) area where the information necessary to reproduce the data recorded in the data area is phase-encoded and recorded in the form of the zonal pit rows (11).

This optical disk prevents from duplicating the zonal pit rows in the PEP area with the RF Copy technology. Since the information necessary for reproducing data recorded in the data area is recorded in the zonal pit rows, it is impossible to reproduce data recorded in the data area. Since this invention needs no detecting circuit or no detecting software algorithm for detecting the disk types in the reproducing apparatus or the like, it may lead no increase in cost. Since this invention prevent from illegally duplicating data or manipulating the apparatus or the like, it is possible to prevent from illegally reproducing data recorded in the data area with reliability. Since this invention enable to mold the disk with the PEP area and the data area at one shot with a stamper machine, it may lead to excellent productivity without increasing its production cost.

In one aspect of the optical disk (100) of the present invention, a mirror section (12, 13) may be set between the zonal pit rows (11) in the PEP area. In accordance with this invention, since the mirror section (12, 13) cannot be copied with the RF Copy technology, it is impossible to duplicate the data recorded in the PEP area.

In further aspect of the optical disk (100) of the present invention, the optical disk (100) may be a read-only optical disk where the data recorded in the data area can be only reproduced. In furthermore aspect of the optical disk of the present invention, the optical disk may be a partial ROM disk where some data was recorded in one part in the area in advance.

In furthermore aspect of the optical disk (100) of the present invention, the width of the PEP area in the radial direction of the optical disk (100) may be twice or more as large as the maximum throw of an eccentric of the optical disk (100). In accordance with this invention, since the width of the PEP area in the radial direction of the optical disk is at least twice or more as large as the maximum throw of an eccentric of the optical disk, it is possible to read the data recorded in the PEP area without using the tracking servo control of the pick up. It is possible to reproduce the data recorded in the PEP area promptly and with reliability, when the data of the optical disk is reproduced legally.

The above object of the present invention can be achieved by a copy preventive method for preventing from copying data recorded in an optical disk (100) provided with: a data area where data to be reproduced is recorded; and a PEP area where the information necessary to reproduce the data recorded in the data area is phase-encoded and recorded in the form of zonal pit rows (11), wherein the copy preventive method is provided with a process for recording a signal which prevents from recording the zonal pit rows (11) into the area, which is equivalent to the PEP area of the optical disk(100), of a recordable optical disk (200).

In accordance with this invention, it is impossible to copy the zonal pit rows in the PEP area with the RF Copy technology. Since the information necessary for reproducing the data recorded in the data area is recorded in the zonal pit rows, it is impossible to reproduce the data recorded in the data area. Since there is no necessity for detecting circuits for detecting the disk types in the reproducing apparatus, it may lead no increase in cost of the apparatus. Since this invention prevents from illegal duplication by manipulating the apparatus or the like, it is possible to prevent from reproducing the data recorded in the data area with reliability. Since the signal which prevents from recording the zonal pit rows is recorded in the area, which is equivalent to the PEP area of the optical disk, of a recordable optical disk, it is possible to prevent from copying and reproducing the data of the PEP area of the optical disk with reliability.

The above object of the present invention can be achieved by a recordable optical disk (200), which can prevent from copying data recorded in an optical disk (100) provided with: a data area where data to be reproduced is recorded; and a PEP area where the information necessary to reproduce the data recorded in the data area is phase-encoded and recorded in the form of zonal pit rows (11), wherein the recordable optical disk (200) has a signal which prevents from recording the zonal pit rows (11) into the area, which is equivalent to the PEP area of the optical disk (100), of the recordable optical disk (200).

In accordance with this invention, this recordable optical disk has a signal which prevents from recording the zonal pit rows in the area, which is equivalent to the PEP area of the optical disk, of the recordable optical disk. It is possible to prevent from copying and reproducing the data of the PEP area of the optical disk with reliability.

In one aspect of the recordable optical disk (200) of the present invention, a signal is recorded in the area, which is equivalent to the PEP area of the optical disk (100), of the recordable optical disk (200), and the signal forms its zone within the area; and the frequency of occurrence of the zonal signal of the recordable optical disk (200) is not integral multiples of the frequency of occurrence of the pit rows (11) of the optical disk (100), when the both disks rotate in the same rotation number separately.

In this case, when the data in the area, which is equivalent to the PEP area of the optical disk, of the recordable optical disk is reproduced, it is impossible to produce the synchronized signals necessary for the rotation of the disk or the reproducing action, and it is impossible to read out the data recorded in this area.

### BRIEF DESCRIPTION OF THE DRAWINGS

FIG. 1 is a plane view showing the configuration of an optical disk of the present invention;

FIG. 2 is a diagram showing the physical structure of the optical disk of the first embodiment;

FIG. 3 is a diagram showing the structure of the PEP (Phase Encoded Part) area;

FIG. 4A is a diagram showing the reproduction wave when the data in the PEP area is reproduced;

FIG. 4B is a diagram showing the waveform after digitizing the reproduction waveform;

FIG. 5 is a plane view showing the configuration of an recordable optical disk of the present invention; and

FIG. 6 is a diagram showing the physical structure of the recordable optical disk of the second embodiment.

### DETAILED DESCRIPTION OF THE PREFERRED EMBODIMENTS

—The embodiment of the optical disk—

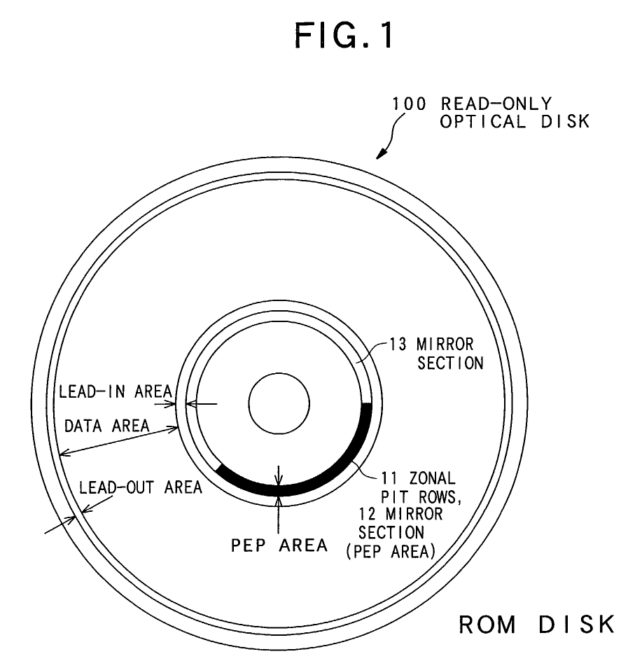

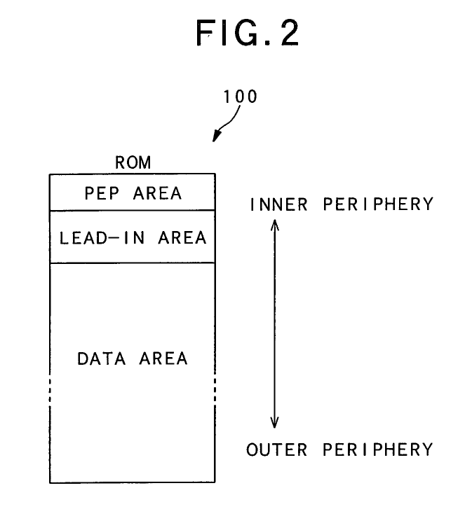

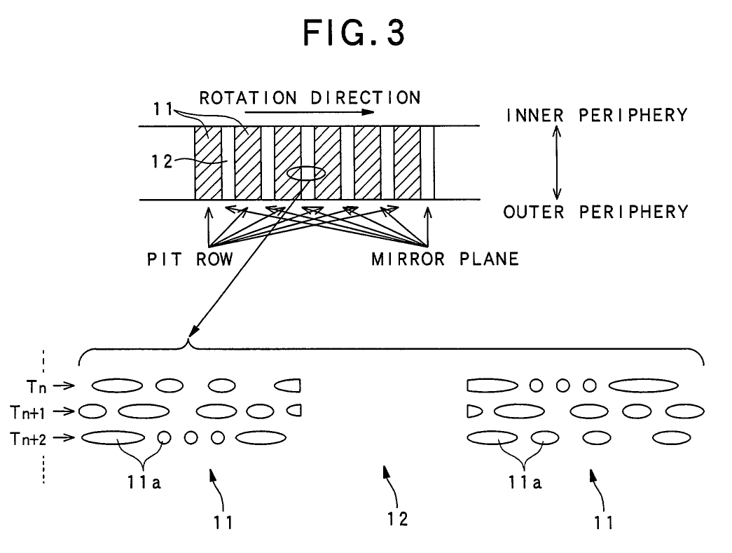

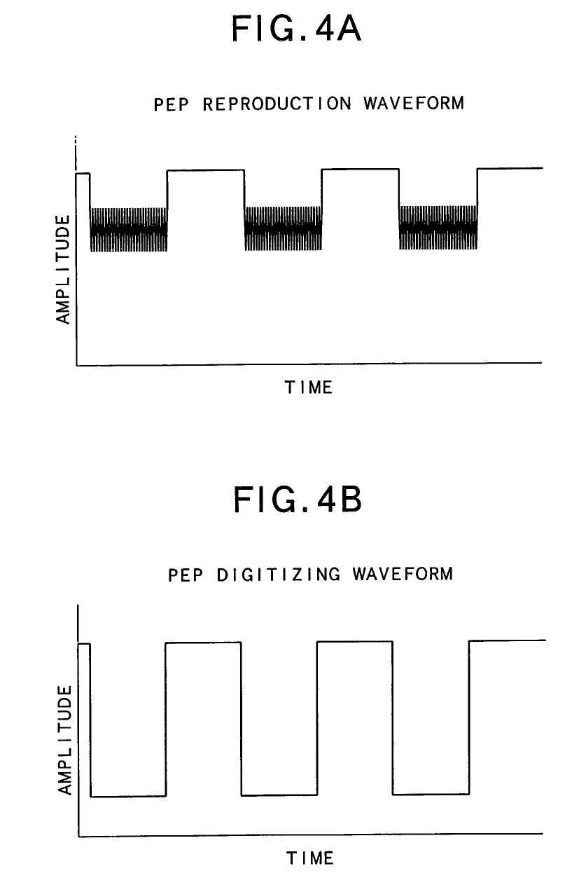

A preferred embodiment which the optical disk of the present invention is applied to the ROM disk will now be described with reference to FIGS. 1 to 4. FIG. 1 is a plane view showing the configuration of an optical disk of the present invention. FIG. 2 is a diagram showing the physical structure of the optical disk of this embodiment. FIG. 3 is a diagram showing the structure of the PEP (Phase Encoded Part) area. FIG. 4A is a diagram showing the reproduction waveform when the data in the PEP area is reproduced, and FIG. 4B is a diagram showing the waveform after digitizing the reproduction waveform.

As FIG. 1 and FIG. 2 show, the read-only optical disk 100 of this embodiment comprises the PEP area, the Lead-in area, and the data area in the radial direction from the inner periphery to the outer. This Lead-in area and the data area have essentially the common structure of the respective areas in DVD (Digital Versatile Disk).

As FIG. 1 and FIG. 3 show, a plurality of the zonal pit rows arranged along the radial direction of the disk form the PEP area. The zonal mirror sections 12 are formed between the adjacent pit rows 11. As FIG. 1 shows, the zonal pit rows are not formed on the whole circumference of the optical disk 100, but only on a small part of the circumference of the optical disk 100. In the area where the zonal pit rows are not formed, the mirror section 13 is formed.

As FIG. 3 shows, a plurality of the pits 11a are formed respectively along a plurality of the trucks Tn, Tn+1, . . . , arranged in the circumference of the optical disk 100 in each pit rows 11. In the optical disk 100 of this embodiment, since a pit itself is not used as data, the length of each pit in the circumference direction (rotation direction) of the optical disk may be arbitrary, for example, at random.

In the optical disk 100 of this embodiment, pit rows 11 and an array in the mirror section 12 in the circumference direction (rotation direction) are used as data. This data has been processed by being phase-encoded. This data contains the information necessary to reproduce the data recorded in the data area, such as a standard book or version code to which the disk is compliant, the information of the physical structure of the disk, or the last address of the data area or the like. This data may contain the information necessary to the copyright protection, such as the key information necessary to de-scramble data, copy control information (CCI) on the contents of the data, or a user rule or the like.

When the optical disk 100 is legally reproduced, the PEP area is first traced. As FIG. 4A shows, since the portion of the pit rows 11 and the portion of the mirror section 12 are different in the output average levels, the binary signal shown in FIG. 4B is obtained by putting the output signal of the pick up through the filter or the like.

As described before, the data obtained as a binary signal contains the information necessary to reproduce the data recorded in the data area. Therefore, when the data recorded in the data area is reproduced, this information is done with phase decoding and used.

As mentioned before, in the optical disk 100 of this embodiment, a pit itself is not used as data, only the physical relationship between the pit rows 11 and the mirror section 12 is used as data. The pit rows 11 and the mirror section 12 form the zone area in the radial direction of the optical disk 100. Thus the physical relationship arranges so that the equivalent value can be obtained, even if the pit rows 11 and the mirror section 12 shift in the radial direction of the optical disk 100 within the PEP area. Therefore, when the read-out spot irradiated by the pick up is within the PEP area, the data recorded in the PEP area is completely read out. The width of the PEP area in the radial direction of the optical disk 100 is twice or more as large as the maximum throw of an eccentric of the optical disk 100. Therefore, when the optical disk 100 rotates under the condition that the pick up is fixed in the radial direction of the optical disk 100 so that the spot by the pick up may be within the PEP area, it enables the spot by the pick up to keep within the PEP area. Thus, in this embodiment, it is not necessary to control the position of the pick up by the tracking servo control. It is possible to read the data within the PEP area promptly and with reliability.

Next, the case that the data recorded on the optical disk 100 is copied with the RF Copy technology will be explained.

When the data recorded on the optical disk is copied with the RF Copy technology, the reproduction apparatus (recording and reproduction apparatus) performs the tracking control process of the pick up in the PEP area, as well as the reproduction apparatus performs in the data area. However, as mentioned above, in the PEP area of the optical disk 100, the pit rows 11 and the mirror section 12 are arranges one after the other. In the most area along the circumference direction of the optical disk 100, the mirror section 13 where the mirror planes are consecutive arranges. Therefore, when the data in the PEP area is copied with the RF Copy technology, it is impossible to do the tracking servo control of the pick up in the mirror section 12 or the mirror section 13. Furthermore, even if it is possible to do the tracking servo control of the pick up, it is impossible to recreate the border area between the mirror section 12 and the mirror section 13, or the border between the mirror section 12 and the pit rows 11. That is to say, even if the data recorded in the PEP area of the optical disk 100 is copied to the other disk with the RF Copy technology, it is impossible to read out the data recorded in the PEP area since the data in the PEP area cannot be duplicated and be reproduced. Furthermore, since the data in the PEP area, as mentioned before, contains the information necessary to reproduce the data in the data area, even if the data in the data area can be duplicated, it is impossible to reproduce it. Furthermore, the PEP area is located in the most inner area of the disk. When the pick up reads the PEP area, the inner stopper prevents the pick up head from moving inward. Thus the PEP area can be copied to neither RW disk nor R disk using a tracking system, because the pick up head can not move inward any more.

Thus, in the optical disk 100 of this embodiment, the data is recorded in the PEP area in the status which the data cannot be duplicated with the RF Copy technology, and the data in the data area cannot be reproduced without the data. It is possible to prevent from duplicating and reproduce the data with the RF Copy technology with reliability. Furthermore, the reproduction apparatus needs no detecting circuit for detecting the disk types. It leads no increase in cost of the reproduction apparatus. Since it is possible to manage the copy without detecting the disk types, it is possible to prevent from illegally copying by manipulating the reproduction apparatus.

In the above-mentioned embodiment, it is possible to form the whole area where the data is recorded, containing the PEP area, at one shot with a stamper molding. It needs no recording the data on every disk respectively. Thus, it leads no increase in cost of its production. It is efficient in mass production.

In the above-mentioned embodiment, the case that the present invention is applied to a ROM disk which is not allowed to write down the data has been explained. It is possible to apply the present invention to a so-called partial ROM disk where some data was recorded on some part of the disk in advance and some data is allowed to be written down in the other part of the disk.

—The embodiment of the recordable optical disk—

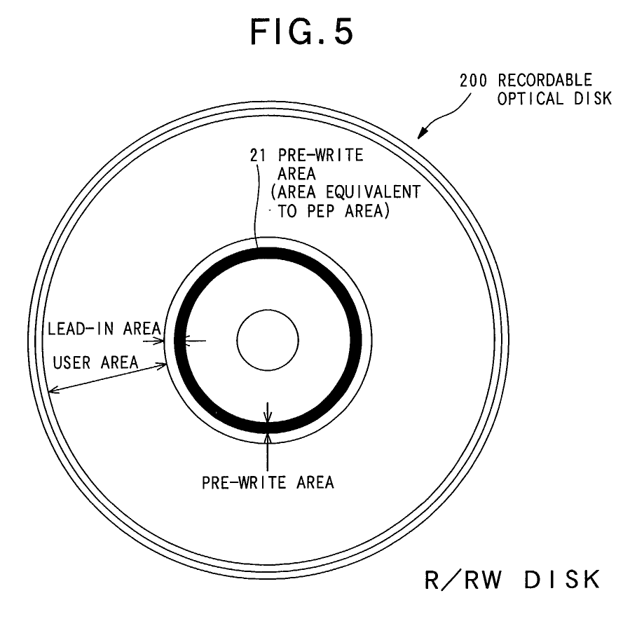

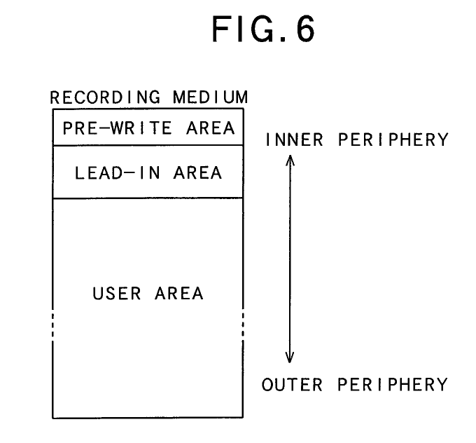

An embodiment of the recordable optical disk of the present invention will be described with reference to FIG. 5 and FIG. 6. FIG. 5 is a plane view showing the configuration of a recordable optical disk of this embodiment. FIG. 6 is a diagram showing the physical structure of the recordable optical disk of this embodiment.

The recordable optical disk 200 of this embodiment is a recordable optical disk (R disk or RW disk) which makes it possible to prevent more strictly from duplicating and reproducing the data recorded on the above-mentioned reproduction specific optical disk 100.

As FIG. 5 and FIG. 6 show, the recordable optical disk 200 of this embodiment comprises the pre-write area 21, the Lead-in area, and the data area into which the user can write down in the radial direction of the disk from the inner periphery to the outer respectively. The pre-write area 21 of the recordable optical disk 200 is located in the equivalent position to the position of the PEP area of the optical disk 100.

As FIG. 1 and FIG. 3 show, the pre-write area 21 comprises a plurality of the zonal pit rows, which arrange along the radial direction of the disk, and the mirror section in the circumference direction (rotation direction) of the disk one after the other, as well as the PEP area of the optical disk 100 does. However, the recordable optical disk 200 forms the zonal pit rows in the whole circumference of the disk. This is different from one of the optical disk 100. The recordable optical disk 200 is formed so that the frequency of occurrence of the zonal pit rows which is obtained when the pre-write area 21 of the recordable optical disk 200 is reproduced may not be integral multiples of the frequency of occurrence of the zonal pit rows 11 of the optical disk 100. That is, when the recordable optical disk 200 and the read-only optical disk 100 rotate in the same rotation number separately, the above-mentioned frequencies of occurrence are not integral multiples each other.

As mentioned above, the position of the pre-write area 21 of the recordable optical disk 200 is equivalent to the position of the PEP area of the optical disk 100. Thus, when the data recorded in the PEP area of the optical disk 100 is duplicated with the RF Copy technology or other method, the data is recorded into the pre-write area 21 of the recordable optical disk 200. However, as mentioned above, the frequency of occurrence of the zonal pit rows in the pre-write area 21 and the frequency of occurrence of the zonal pit rows in the PEP area are not integral multiples. Thus, since synchronized signals necessary to the rotation of the disk or the reproduction of the data cannot be produced, the data which is recorded in the pre-write area 21 of the recordable optical disk 200 cannot be read out. Therefore, there is no possibility that the data in the PEP area is recorded into the pre-write area 21 with the possibility of reproduction.

Therefore, even if the data in the data area of the optical disk 100 is recorded into the user area of the recordable optical disk 200, it is impossible to reproduce the data of this data area, as long as the data of the PEP area cannot be reproduced.

Since the zonal pit rows in the pre-write area 21 of the recordable optical disk 200 are formed in the whole circumference of the disk, it is possible to prevent from recording data, even if the data on the PEP area is written in any angle.

When the recordable optical disk 200 of this embodiment is applied, it is possible to prevent from illegally copying data with more reliability, since the data in the PEP area of the optical disk 100 cannot be recorded with the possibility of reproduction.

Since the pre-write area 21 of the recordable optical disk 200 is molded with a stamper machine at one shot, as well as the PEP area of the optical disk 100, it leads no increase in cost of its production, namely, it is excellent in mass production.

In this embodiment, the case of the zonal pit rows formed in the pre-write area as a preventive means for preventing from recording data in the PEP area has been explained. The form of the preventive signal for preventing from recording data in the PEP area does not set limits.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-340350 filed on Nov. 6, 2001 including the specification, claims, drawings and summary is incorporated herein by reference in its entirety.

What is claimed is:

1. An optical disk comprising:
a data area where data to be reproduced is recorded; and
a PEP area where the information necessary to reproduce the data recorded in the data area is phase-encoded and recorded in the form of the zonal pit rows.

2. The optical disk according to claim 1, wherein
a mirror section is set between said zonal pit rows in said PEP area.

3. The optical disk according to claim 1, wherein
said optical disk is a read-only optical disk where said data recorded in said data area can be only reproduced.

4. The optical disk according to claim 1, wherein
the width of said PEP area in the radial direction of said optical disk is twice or more as large as the maximum throw of an eccentric of said optical disk.

5. A copy preventive method for preventing from copying data recorded in an optical disk comprising: a data area where data to be reproduced is recorded; and a PEP area where the information necessary to reproduce the data recorded in said data area is phase-encoded and recorded in the form of zonal pit rows, wherein
said copy preventive method comprises a process for recording a signal which prevents from recording said zonal pit rows into the area, which is equivalent to said PEP area of said optical disk, of a recordable optical disk.

6. A recordable optical disk, which can prevent from copying data recorded in an optical disk comprising: a data area where data to be reproduced is recorded; and a PEP area where the information necessary to reproduce the data recorded in said data area is phase-encoded and recorded in the form of zonal pit rows, wherein
said recordable optical disk records a signal which prevents from recording said zonal pit rows into the area, which is equivalent to said PEP area of said optical disk, of said recordable optical disk.

7. The recordable optical disk according to claim 6, wherein
a signal is recorded in said area, which is equivalent to said PEP area of said optical disk, of said recordable optical disk, and said signal forms its zone within said area; and
the frequency of occurrence of said zonal signal of said recordable optical disk is not integral multiples of the frequency of occurrence of said pit rows of said optical disk, when said both disks rotate in the same rotation number separately.
